(19) United States
(12) Patent Application Publication
(10) Pub. No.: US 2017/0213476 A1
(43) Pub. Date: Jul. 27, 2017

(54) SYSTEM AND METHOD FOR TRAINING THE SUBCONSCIOUS MIND

(71) Applicant: Barrie Lynch, Abquaiq (SA)

(72) Inventor: Barrie Lynch, Abquaiq (SA)

(21) Appl. No.: 15/004,893

(22) Filed: Jan. 23, 2016

(51) Int. Cl. G09B 19/00; G09B 5/02

(52) U.S. Cl. CPC G09B 19/00; G09B 5/02

(57) ABSTRACT

The present invention relates to a method of training the subconscious mind by implementing a subliminal program. The subliminal program can be used to train the subconscious mind to quickly assemble various parts of a jigsaw image by preprogramming and visually displaying a set of images for training the subconscious mind. The subliminal program flashes images that represent a piece or group of attached pieces of a jigsaw on an electronic screen to train the subconscious mind. Further, the set of images that are pre-designed using attractiveness attributes are embedded with the set of images with a strong subconscious attraction by using known artistic and hypnotic techniques. Furthermore, the subliminal program can improve the learning and memorizing capability by flashing the assembled jigsaw images briefly on screen outside the comprehension level of the conscious mind but within the level of the subconscious.

### FIELD OF THE INVENTION

The present invention generally relates to training the subconscious/unconscious mind (from here forth referred to as the subconscious) subliminally, and more particularly relates to uploading a subliminal program to the subconscious using specially designed artwork and techniques for training the subconscious mind to enhance the learning, mapping, or memorizing techniques of an individual.

### BACKGROUND OF THE INVENTION

It is a well-known fact that the subconscious mind has the capability to grasp and calculate information at much faster speeds and greater volumes than the conscious mind. Example: The conscious mind can listen to and process data for a maximum number of three verbal conversations, at the same time. The sub-conscious mind can do this and simultaneously run the respiratory, cardio, olfactory, endocrinal, balance, sensory etc. systems at the same time. Experts estimate that the capacity of calculation of the subconscious mind is anywhere between 10,000 to 1 million times that of the conscious mind. Hence, it is clearly more sensible to train the subconscious mind directly to remember information rather than training the subconscious mind indirectly using the conscious mind as a gateway, with methods such as conscious verbal repetition e.g. 10×9=90, 10×10=100 etc.

There are currently various subconscious subliminal software training methods available in the market to train the subconscious mind directly by bypassing the conscious. Examples include: 1) teaching languages in an audio subliminal way, by training the mind subconsciously, while the user is in a state of sleep or hypnosis and 2) communicating information at very fast speeds, outside the spectrum of perception of the conscious but inside the spectrum of perception of the subconscious from visual or phonic sources.

Although such methods have shown success for certain types of training than the conventional training programs, few such program exist to teach people in fields such as reading and writing. Many hours and effort has to be spent on training methods for the conscious mind (such as typing games, repetitive reading).

Hence, there is a need for a method that implements the subliminal program for training the subconscious mind for reading and writing. It will need to use optimal information in such a way that the efficiency of training the subconscious mind is enhanced. Further, the subliminal program must be capable of training the subconscious mind with minimal effort and time to avoid loss of concentration due to distractions mentioned below in [0006 and 0007] and in fact to take advantage of such distractions and use them as part of the training mechanism.

Training the subconscious mind has big limitations. The subconscious mind is very easily distracted. The reason is that the subconscious mind has natural Automatic Response Mechanisms to certain stimulus (e.g. flight, fight or freeze reaction to danger), which override all other bodily systems, including thought, when triggered. This can reduce the efficiency of training the subconscious mind using subliminal messages etc.

The three main Automatic Response Mechanisms are 1) self-preservation i.e. the “fight or flight” nervous response to a threat, 2) propagation of the species i.e. sexual desire to reproduce, and 3) preservation of members of one's tribe or family. If the subconscious mind senses through the eyes, ears, nose, mouth or touch a threat to either its own self or a family member's existence or if it is sexually attracted to another human, the subconscious mind instantly overrides all other subconscious activities and instantaneously changes the body and brain's functioning to ensure a positive outcome as applicable. For example, the heart rate increases, the endocrine systems secretes adrenaline, the muscles tense if danger presents itself in preparation to a “fight, flight, or freeze”. Based on the understanding of the working of the subconscious mind, the automatic response mechanism can be used for training the subconscious mind efficiently.

### SUMMARY OF THE INVENTION

The present invention relates to a system and method for implementing a subliminal program to train the subconscious mind, wherein the subliminal program trains the subconscious mind by utilizing the following:
1) A set of specially designed primary images (of human body parts) and a set of existing secondary images (of numbers and letters) representing the set of objects, wherein the secondary images are represented with a set of numbers of letters and is designed to encase the set of primary images
2) Blending one of each of the set of primary images (of human body parts) with one of each of the set of secondary images (of numbers and letters) to form a new tertiary image (of attractive numbers and letters).
3) Reducing visual content in the artwork and enhancing the strength of attractiveness of the set of primary images so that the subconscious can upload the primary image to the brain as fast as possible and therefore better recognize each secondary image that the brain has no attraction, and which is displayed on screen at the same time as the primary image to form the tertiary image.
4) Giving strong outline to the images so that when they are reduced in size so that the detail can not be perceived that the form is still clearly visible and attractive to the subconscious.
5) Designing the images in grey scale, black and white colors only to take advantage of how the subconscious forms images from electronic signal from the optic nerve—images in the mind are first produced in black, white and grey scale and then turned into color. Therefore black, white and grey scale images are more quickly absorbed into the subconscious memory than color. This also removes the possibility that the image will trigger ‘color shock’ in the subconscious mind, which is where the research has shown that exact replica colored images of the same grey-scale image trigger a fear reaction in the subconscious and thus rejection of the image by the mind.
6) Using the method of flashing the jigsaw images on screen for periods circa 0.03 seconds which have been shown to be long enough for the subconscious mind to view but to short for the conscious mind leaving the user consciously unaware that they are viewing the images.
7) Designing different primary images to blend with the same secondary image (letter or number) to form a varied set of tertiary images (e.g. varied alphabets however with the same secondary image). This will overcome the natural ability of the subconscious called “resistance” where when the subconscious mind recognizes that it has seen a certain sexually attractive image or groups of tertiary images before it loses interest and attraction for the images. By varying the primary images and keeping the secondary images constant the tertiary images will remain attractive and the program will still be able to flash repeatedly the primary images and the brain will remember the form of these images or groups of images

In an embodiment, the present invention implements the subliminal program to train the subconscious mind to enhance the learning, mapping, or memorizing capabilities of an individual.

The set of primary images are designed with an optimal minimum number of body parts to aid the subconscious to recognize the objects easily and quickly, which is critical as research has shown the subconscious mind has limitations in remembering objects of even moderate complexity. The primary images are designed to blend with the form of the secondary image. For example, the natural B shape formed by the human Breast/Pectorals is used to blend with the letter B. The user is given the option to choose from two sets of primary images; a male form from a female form, to allow the users to determine the sexual preference. Further, various body sizes and types have been designed to add a variety of attractive images to overcome ‘resistance’ in the subconscious, which is where the subconscious mind looses interest in an image if viewed frequently which in turn reduces the effectiveness of the program.

In another embodiment, the subliminal program trains the subconscious mind by embedding the attractiveness attribute to each image in the set of images that is preprogrammed for training the subconscious mind. The attractiveness attribute embedded into the set of images trains the individual by associating the secondary image with the strength of attraction attached towards each related primary image. The set of primary images of a human body can be made attractive by using various existing techniques such as making the set of images 3D oriented, applying differing shade and balance, contrast between the primary and secondary images, changing the scale of the set of images. This will again increase the possibility that the image is uploaded and remembered successfully by the subconscious mind.

In another embodiment, the present invention implements the subliminal program to train the subconscious mind by using the images as pieces of a jigsaw and putting pieces of the jigsaw together to form a complete picture. Randomly 2-5 pieces of the jigsaw are placed in their correct places and are displayed on the display screen for training the subconscious mind. For typing training, the subliminal program flashes the images as they are seen on conventional key boards e.g. QWERTY, FGHJKL, XCVBN. By flashing these groups of images using the subliminal program, the user's subconscious will put the groups of images together to form an image of the full jigsaw i.e. the keyboard in the subconscious memory. Training the subconscious mind by flashing the jigsaw images enables the subconscious to form a complete image of jigsaws from their component pieces, example the QWERTY keyboard pattern, quickly without the need to constantly learn the letters positions using conscious training techniques. This takes advantage of two natural abilities of the subconscious, one, to instinctively see two to five objects, when grouped together as one larger object. Experts believe this ability stems from millions of years of seeing five fingers on the same hand as one object (i.e. a hand and not five fingers). This ability to see six or more objects as one object is not natural. The second is the ability of the subconscious to store long term memories in broken parts in different parts of the brain and reassemble them when someone remembers an event. e.g. smells, sounds, sights of a memory are all stored in different parts of the brain and then reassembled as one memory in (i.e. a jigsaw) of all sensory experiences of an event to form the complete memory.

In another embodiment, the present invention implements using the method of Clashing the jigsaw images on screen for periods circa 0.03 seconds which have been shown to be long enough for the subconscious mind to view but to short for the conscious mind leaving the user consciously unaware that they are viewing the imagesResearch has shown the subconscious mind's ability to see subliminal images when flashed for periods as short as 0.03 seconds, and theorize that the process of flashing images and the ability to put together a jigsaw image instantaneously when shown just one piece was developed when humans were hunter gatherers thousands of years ago. Example: when humans were faced with situations that endangered their life, such as briefly seeing the tail of a tiger or a snake, from the corner of your eye in the forest, the human subconscious could quickly form the jigsaw image of a tiger/snake which allowed for a immediate escape even before the conscious mind had time to comprehend the danger.

In another embodiment, the present invention implements the method of learning by ‘Subconscious Repetition’: Just like the conscious method of learning by repetition, this method of learning is by subconscious repetition, where the conscious mind and thus the conscious user is totally unaware of the process and therefore can continue working undisturbed on a computer or watching TV. In another embodiment, the present invention implements shown the subconscious mind's ability to see subliminal images when flashed for periods as short as 0.03 seconds, and theorize that the process of flashing images and the ability to put together a jigsaw image instantaneously when shown just one piece was developed when humans were hunter gatherers thousands of years ago. Example: when humans were faced with situations that endangered their life, such as briefly seeing the tail of a tiger in the forest or seeing a tiger's legs under a bush, the human subconscious could quickly form the jigsaw image of a tiger which allowed for a immediate escape movement even before the conscious mind had time to comprehend the danger.

### BRIEF DESCRIPTION OF DRAWINGS

FIG. 1 illustrates a working overview of the system for implementing the subliminal program to train the subconscious mind based on reading and/or typing the images.

FIG. 2 illustrates a flow-chart that explains the process of implementing the subliminal program to train the subconscious mind based on reading and/or typing the images.

FIG. 3 illustrates the system overview of components used for implementing the subliminal program to train the subconscious mind based on reading and/or typing the images.

FIG. 4 illustrates some letters of alphabet used to represent the human body with the optimal minimum number of body parts according to an embodiment of the present invention.

FIG. 5 illustrates an example of a human alphabet where the positions held by the 1-3 female images in each letter is designed to attract a male's subconscious to the image.

FIGS. 6a and 6b illustrate an overview of human body images embedded with one or more attractiveness attributes according to an embodiment of the present invention.

FIGS. 7a and 7b illustrate keyboard images represented in the form of a jigsaw puzzle according to an embodiment of the present invention.

### FIGURE DESCRIPTION

100—A system for implementing a subliminal program to train the subconscious mind
101—A network within which the system works
102—A set of primary images used for embedding attractiveness attributes
104—A server module used for embedding attractiveness attributes in the set of primary images and blending with the secondary images.
104—A set of secondary images corresponding with the set of primary images
104—A set of tertiary images displayed on the screen
300—A system overview of components
301—A database of predesigned images
302—A blending module
303—A display module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, the term primary image refers to an image created with attractiveness attributes embedded in the image that is used for training the subconscious mind. In an embodiment, the term secondary image refers to an image created without any attractiveness attributes embedded in the image for typing training, attractive images for reading and attractive body parts are used for training the subconscious mind. In an embodiment, the term tertiary image is an image, which combines both the primary and the related secondary image to form a tertiary image.

In an embodiment, the attractiveness attributes embedded in the image enhances the attractiveness of the image. For example, a normal image embedded with 3-Dimensional effect can increase the attractiveness of the image. As another example, a normal image embedded with scaling and curving features enhances the attractiveness of the image.

In the proposed invention, for the purpose of explanation, the subliminal program displays for a short span of time (circa 0.03 second) on a display screen periodically at intervals of between 0.5 to 5 seconds, an alphabet and numbers 1-9, that represent a human body. In an embodiment, the subliminal program can depict other objects that are represented by using letters, numbers, and images as a set of secondary images. Further, the object is displayed on the display screen of an electronic device for training the subconscious mind.

In an embodiment, the system allows the user to specify the primary image, and the attractiveness attribute to be associated with the primary image through the User Interface displayed on the display screen. Further, the user interface displayed on the display screen allows the user to specify the duration for which the tertiary image(s) can be displayed on the display screen.

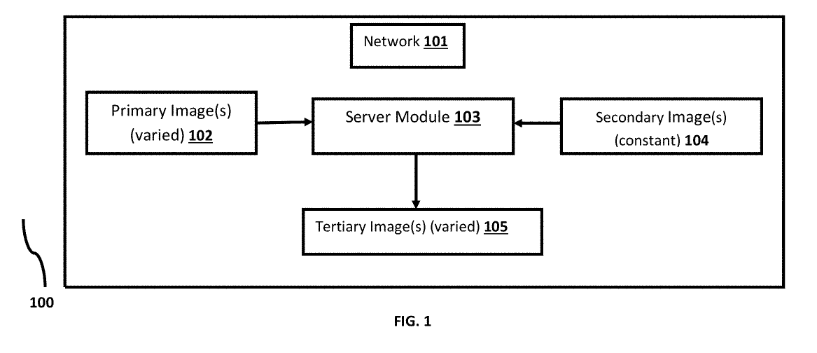

Referring to FIG. 1, illustrates a working overview of the system 100 for implementing the subliminal program to train the subconscious mind based on reading and/or typing the images. In an embodiment, the system 100 comprises of a Server module 103 that accepts a set of primary images 102 as input and determines the attractiveness attributes required to be associated with the set of the primary images 102. Further, the Server module 103 accepts a set of secondary images 104 as input to blend the primary images (associated with the attractiveness attributes) with the set of secondary images, to provide tertiary images. In an embodiment, the set of secondary images 104 are not associated with the attractiveness attributes. However, the set of secondary images 104 are blended with the set of primary images that are associated with the attractiveness attributes. Further, the server module 103 is configured to display the tertiary images 105 on the display screen to train the subconscious mind. For example, the elbow part of the arm (that is considered as a primary image) can be associated with a letter “L” that is considered as a secondary image. Further, the primary image can be associated with an attractive attribute that highlights the edges/corners of the elbow part for enhancing the attractiveness of the tertiary image. Further, the tertiary image (determined after blending the primary image with the secondary image) can be displayed on the display screen.

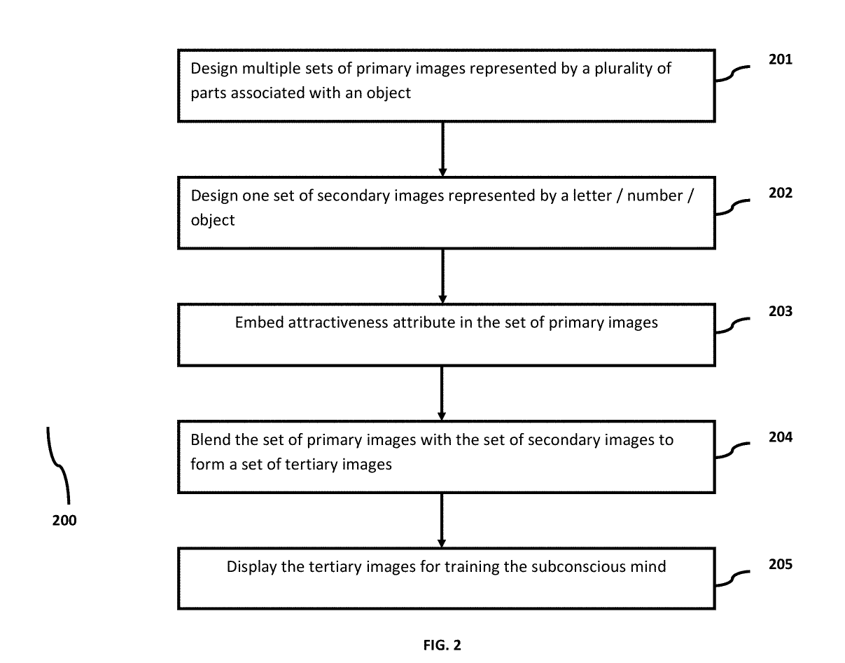

Referring to FIG. 2 illustrates a flow-chart 200 that explains the process of implementing the subliminal program to train the subconscious mind based on reading and/or typing the images. Initially, at step 201, the method 200 is used to design a set of primary images that are represented by a plurality of parts of an object, wherein the object can be a human body, an animal body, a wooden structure, or the like. For example, the hand fingers, the knee joints, or the anklets can be used as the set of primary images. At step 202, the method 200 is used to design a set of secondary images the represented by alphabets/numbers/objects. For example, the letter “I” considered as a secondary image associated with an eye, which is considered as a primary image. At step 203, the method 200 is used to associate an attractiveness attribute with the primary image to enhance the attractiveness factor of the primary image. For example, the elbow of the human body can be highlighted with edges to enhance the attractiveness of the primary image. At step 204, the method 200 is used to blend the primary image with the secondary image to form a tertiary image, which can be displayed on the display screen. At step 205, the method 200 is used to display the tertiary images on the display screen for training subconscious mind.

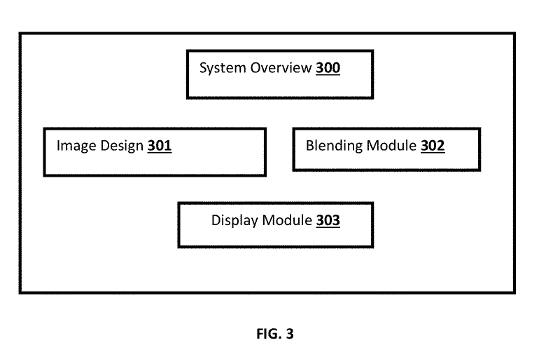

Referring to FIG. 3 illustrates the system overview of components 300 used for implementing the subliminal program to train the subconscious mind based on reading and/or typing the images. In an embodiment, the system 100 used for implementing the subliminal program to train the subconscious mind comprises of the following components 300: an Image designing module 301, a Blending module 303, and a Display module 304. The Image designing module 301 is configured to design a set of primary images and a set of secondary images. The Blending module 303 is configured to blend the set of primary images with the set of secondary images to form a set of tertiary images. The Display module 304 is configured to display the set of tertiary images on the display screen for training the subconscious mind.

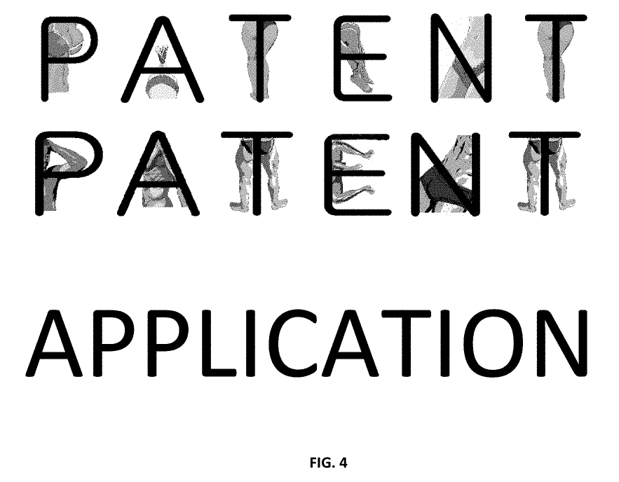

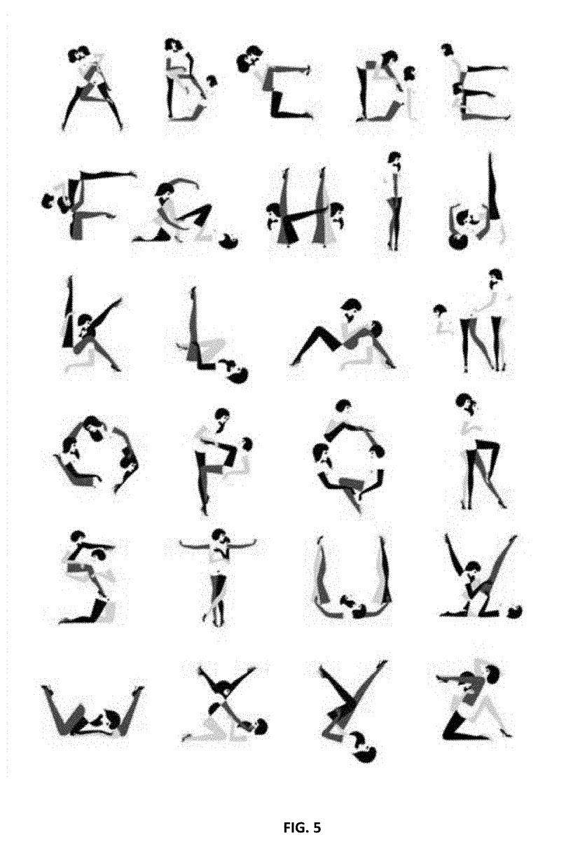

Referring to FIG. 4, illustrates an overview of some letters of the alphabet spelling “patent application” used to represent the human body with an optimal minimum number of body parts. The human body represented by alphabets is an already existing technique, refer to FIG. 5. In an embodiment, this subliminal program represents the human body using an optimal minimum number of body parts as a set of primary images and the set of primary images is displayed on the display screen for training the subconscious mind. Since, the set of primary images is created by using optimal minimum number of body parts; the subconscious mind can recognize the secondary images quickly and easily. Using the optimal minimum number of body parts facilitates the subliminal program to allow the subconscious mind to easily recognize the secondary image that is created using a letter or a number or an object. Further, if sharp or curved edges are used in the primary image, sharp or curved edges letters included in the secondary image will bring more balance between the two symbiotic images in forming the tertiary image.

Referring to FIG. 5, this illustrates an overview of a human female alphabet using different body positions and poses with sets of 1-3 human figures. The subliminal program uses similar attraction techniques with human bodies to trigger the subconscious radar. The subliminal program is implemented to develop 26 (×2 no. male and female) images (each in the form of a different letter of the alphabet) to form a human alphabet and 10 numbers (1-9) (×2 no. male and female) images.

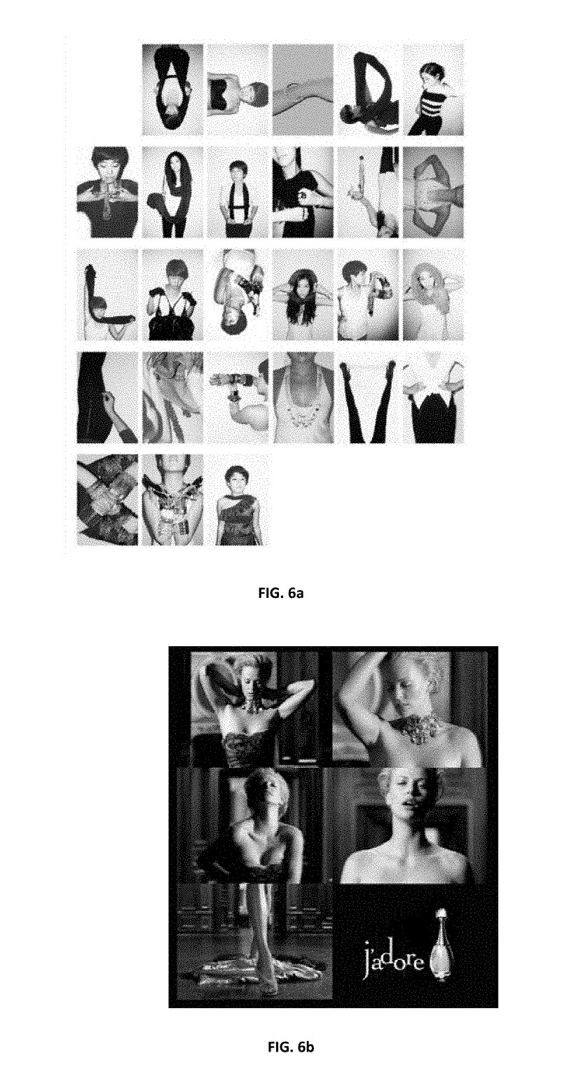

Referring to FIGS. 6a and 6b, illustrate an overview of human body images associated with one or more attractive attributes. In an embodiment, the attractive attributes associated with the image can be applied by the subliminal program by using any of the known techniques such as providing 3-Dimensional visual display, applying shade balance to the images, applying scale and exact form to the images. In an embodiment, as the images applied with attractive attributes are displayed on the display screen by the subliminal program, the subconscious mind is trained along with a sense of attraction associated with the displayed images. Hence, the subconscious learning or training becomes more effective. For example: A beer lid opened with a foam overflowing to the rim of the bottle depicted with a 3D visual display is more attractive to the subconscious compared with a normal/plain beer image. Further, the bottle depicted with a 3D visual display can be associated with a letter “L” (representing the secondary image) for training the subconscious mind to read and learn the letter “L” easily. Hence, the subconscious mind can be more effectively trained with attractiveness attributes associated with the image.

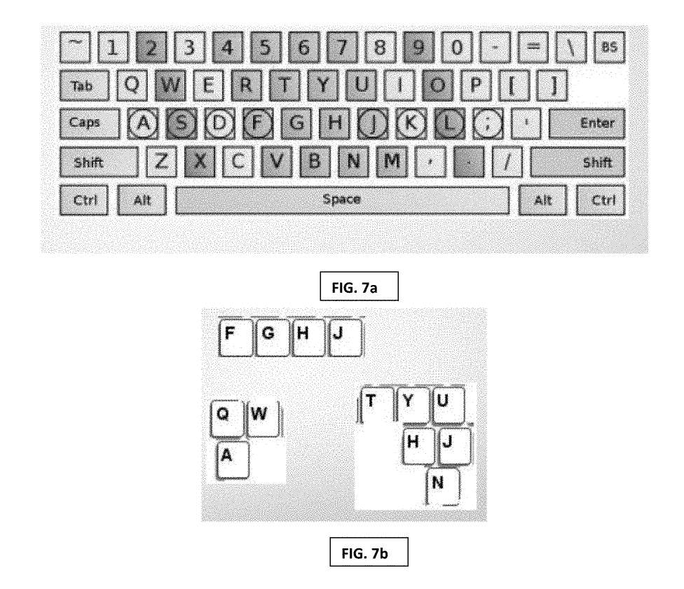

Referring to FIGS. 7a and 7b, illustrate keyboard images represented in the form of a jigsaw puzzle. As depicted in FIG. 4a, the computer keyboard keys are randomly selected and a jigsaw is formed with a set of keys. FIG. 4b, depicts a jigsaw formed with a set of keys. In an embodiment, the subliminal program displays the jigsaw assembly to form a complete object and the jigsaw assembly trains the subconscious mind and ingrains the jigsaw assembly in the brain of an individual. Training the subconscious mind with the jigsaw assembly reduces/eliminates the need for an individual to repetitively consciously practice keyboard typing or learning words by taking advantage of the subconscious mind's natural ability to complete jigsaws and produce complete jigsaw images. For example, the subliminal program can flash an image of an eye in the screen with the letters EYE so that the subconscious mind will ingrain the image and the letters to form a new jigsaw of 4 letters. The subconscious now remembers the image of an eye is associated with the letters EYE so can read the word “eye’.

In an embodiment, the subliminal program improves the memorizing capability of the brain by training the subconscious mind with pieces of a jigsaw (images) displayed on the display screen and associating these jigsaw images with attractiveness attributes. Further, the pieces of the jigsaw images associated with the attractiveness attributes are assembled/mapped into the subconscious memory effortlessly to form a complete jigsaw image. By improving the memorizing capability of the brain, the subliminal program can enhance the learning capability of an individual. As an example, the following method can be implemented as a reading and typing subconscious training technique for playing the cards game.

The learning and memory capability can be improved by the subliminal program after visually simulating the jigsaw images, associated with the attractiveness attributes.

1. A method for training the subconscious mind by implementing a subliminal program, wherein the method comprises of:
displaying a set of tertiary images on a display screen for training the subconscious mind with the set of tertiary images that is pre-designed based on the set of primary images and the set of secondary images selected by a user.

2. The method as claimed in claim 1, wherein said subliminal program trains the subconscious mind by performing the following actions:
using each image in a set of tertiary image to represent at least one piece of a complete jigsaw;
briefly displaying on a screen, groups of 2-5 of the tertiary images, from the full set of tertiary images, to form a large or complete piece of the jigsaw image; and
assembling the larger pieces of assembled groups of tertiary pieces to form a full jigsaw image by the subconscious mind to engrain the jigsaw image in the mind permanently.

3. The method as claimed in claim 1, wherein the attractiveness attributes embedded in the set of primary images to attract the subconscious mind can be implemented using one of the following techniques: making the set of images 3D oriented, applying differing shade and balance, inverting black and white colors, changing the scale of the set of images, highlighting the contrast between the primary image and the secondary image.

4. The method as claimed in claim 1, wherein the primary images are represented with minimal number of plurality of parts associated with said object for easily recognizing the secondary image.

5. The method as claimed in claim 1, wherein the subliminal program allows a user to specify the set of primary images and the set of secondary images to be associated with an attractiveness attribute through a user interface supported on the display screen.

6. The method as claimed in claim 1, wherein the subliminal program can be configured to display a set of tertiary images on said display screen periodically for the specified span of time for training the subconscious mind through the user interface supported on the display screen.

7. A computer program product comprising computer executable program code recorded on a computer readable non-transitory storage medium, said computer executable program code when executed trains the subconscious mind, will cause actions including:
displaying a set of tertiary images on a display screen for training the subconscious mind with the set of tertiary images that is pre-designed based on the set of primary images and a set of secondary images selected by a user.

8. The computer program product as claimed in claim 7, wherein said product is configured to execute the subliminal program to train the subconscious mind by performing the following actions:
using each image in a set of tertiary image to represent at least one piece of a complete jigsaw;
briefly displaying on a screen, groups of 2-5 of the tertiary images, from the full set of tertiary images, to form a large or complete piece of the jigsaw image; and
assembling the larger pieces of assembled groups of tertiary pieces to form a full jigsaw image by the subconscious mind, which will be engrained in the mind permanently.

9. The computer program product as claimed in claim 7, wherein the attractiveness attributes embedded in the set of primary images to attract the subconscious mind can be implemented using one of the following techniques: making the set of images 3D oriented, applying differing shade and balance, inverting black and white colors, changing shade, changing the scale of the set of images, highlighting the contrast between the primary image and the secondary image.

10. The computer program product as claimed in claim 9, wherein the set of primary images are represented with minimal number of plurality of parts of said object for easily recognizing the secondary image.

11. The computer program product as claimed in claim 8, wherein the subliminal program allows a user to specify the set of primary images and the set of secondary images to be associated with an attractiveness attribute through a user interface supported on the display screen.

12. The computer program product as claimed in claim 8, wherein the subliminal program can be configured to display a set of tertiary images on said display screen periodically for the specified span of time for training the subconscious mind through the user interface supported on the display screen.

13. A system for training the subconscious mind by implementing a subliminal program, wherein the system comprises of a server module and is configured to:
display said set of tertiary images on a display screen for training the subconscious mind with the set of tertiary images that is pre-designed based on a set of primary images and a set of secondary images.

14. The system as claimed in claim 13, wherein said subliminal program trains the subconscious mind by performing the following actions:
using each image in a set of tertiary image to represent at least one piece of a complete jigsaw;
briefly displaying on a screen, groups of 2-5 of the tertiary images, from the full set of tertiary images, to form a large or complete piece of the jigsaw image; and
assembling the larger pieces of assembled groups of tertiary pieces to form a full jigsaw image by the subconscious mind to engrain the jigsaw image in the mind permanently.

15. The system as claimed in claim 13, wherein the attractiveness attributes embedded in the set of primary images to attract the subconscious mind can be implemented using one of the following techniques: making the set of images 3D oriented, applying differing shade and balance, inverting black and white colors, changing the scale of the set of images, highlighting the contrast between the primary image and the secondary image.

16. The system as claimed in claim 13, wherein the primary images are represented with minimal number of plurality of parts associated with said object for easily recognizing the secondary image.

17. The system as claimed in claim 13, wherein the subliminal program allows a user to specify the set of primary images and the set of secondary images to be associated with an attractiveness attribute through a user interface supported on the display screen.

18. The system as claimed in claim 13, wherein the subliminal program can be configured to display a set of tertiary images on said display screen periodically for the specified span of time for training the subconscious mind through the user interface supported on the display screen.

19. The system as claimed in claim 17, wherein the set of primary images and the set of secondary images are designed with a strong outline so that when they are reduced to the minimum size of 1 cm×1 cm the attractiveness of the bodyline is still visible to the subconscious mind.

20. The system as claimed in claim 17, wherein the set of primary images and the set of secondary images representing a plurality of alphabets are flashed frequently for the subconscious mind to recognize the association between the body part and the plurality of alphabets.
